(19) United States
(12) Patent Application Publication
(10) Pub. No.: US 2020/0031562 A1
(43) Pub. Date: Jan. 30, 2020

(54) MULTILAYER PACKING LINER APPARATUS AND METHODS FOR MANUFACTURE THEREOF USEFUL FOR INSULATED CONTAINMENT OF FOOD ITEMS

(71) Applicant: NEW YORK PACKAGING II, New Hyde Park, NY (US)

(72) Inventor: Jeffrey RABIEA, New Hyde Park, NY (US)

(21) Appl. No.: 16/044,504

(22) Filed: Jul. 24, 2018

(51) Int. Cl. B65D 81/38; B65D 65/40; B32B 15/085; B32B 3/12

(52) U.S. Cl. CPC B65D 81/3897; B65D 65/40; B32B 15/085; B32B 2439/70; B32B 2255/205; B32B 2255/10; B32B 2307/304; B32B 3/12

(57) ABSTRACT

A multilayer packing liner includes a first outer layer comprising an insulating material. The insulating material is MYLAR, metallized polypropylene, metallized polyethylene, or nylon. The packing liner includes a first bubble layer including polymeric material and an interstitial layer comprising a polymeric sheet. The interstitial layer interposes the first bubble layer and a second bubble layer. The second bubble layer is formed of polymeric material and configured to define voids or ‘bubbles’ as in the second layer.

### FIELD

The disclosure relates to packing materials. In particular, the disclosure relates to insulating packing liners useful for packing food items for storage, transportation, and delivery.

### BACKGROUND

Packing materials and packaging for packing food items are well-known. Packing temperature-sensitive food items typically requires refrigeration or other insulation means for maintaining a constant temperature, or a temperature within an acceptable range for safe storage of the food items. Such means are well known, particularly for use in the packing and transportation of large quantities of goods.

In recent years, changes in food sourcing, production, and transportation have led to an increased demand for packaging solutions suitable for shipping smaller quantities of food items. For example, small organics farms have extended their business reach and sales volume in recent years. Personal food and grocery delivery services are undergoing rapid and significant growth.

Conventional food item packaging includes liners for providing insulation during transportation and temporary storage. Such liners include a foil liner having a single layer, which lack insulating effectiveness. Such liners also include liners having multiple layers including an insulation layer that contributes to a larger, bulky, and awkward profile that impedes folding and efficient storage of the liner, and contributes to higher packaging material and transportation cost.

### SUMMARY

A need has been recognized for packing liners having both a sufficiently thin profile for efficient and easier packing and transportation, and optimal insulating capability for maintaining temperatures at a range suitable for perishable food items including frozen goods, and goods that require refrigeration while minimizing materials cost.

A multilayer packing liner and method useful for manufacture thereof is provided responsive to said need. A packing liner, in an embodiment of the disclosure, includes a first outer layer comprising an insulating material. The insulating material is MYLAR in one embodiment. In another embodiment, the insulating material is metallized polypropylene. In another embodiment the insulating material is metallized polyethylene. In yet another embodiment, the insulating material is nylon.

The packing liner includes a first bubble layer including a polymeric material configured to define ‘bubbles’—structures defining voids containing air sealed in and surrounded by the polymeric material. The packing liner includes an interstitial layer. The interstitial layer is formed of a polymeric material in an embodiment. In another embodiment, the interstitial layer is formed of MYLAR. In another embodiment, the interstitial layer is metallized polypropylene. In another embodiment the insulating material is metallized polyethylene. In yet another embodiment, the insulating material is nylon.

The interstitial layer interposes the first bubble layer and a second bubble layer. The second bubble layer is formed of a polymeric material and configured to define voids or ‘bubbles’ as in the second layer.

The first bubble layer and the second bubble layer are the only bubble layers in one embodiment wherein the packing liner includes an interstitial layer interposing and directly contacting the bubble layers, a first outer layer directly contacting the first bubble layer opposite the interstitial layer, and a second outer layer directly contacting the second bubble layer opposite the interstitial layer. In an alternative embodiment, a packing liner may include more than two bubble layers, each interposed by an interstitial layer. The outer layers and the interstitial layer(s) of some embodiments form a portion of surfaces of the bubble layer that define and seal the voids therein.

In an alternative embodiment, the insulating layer formed of MYLAR, metallized polypropylene, metallized polyethylene, or nylon is a second layer. A first bubble layer is a first outer layer directly contacting the second layer. A second bubble layer is a third layer, and the second outer layer, directly contacting the second layer.

In another alternative embodiment, the insulating layer formed of MYLAR, metallized polypropylene, metallized polyethylene, or nylon is a second layer. A first bubble layer is a first outer layer directly contacting the second layer. A second bubble layer is a third layer, directly contacting the second layer, opposite the first bubble layer. A fourth layer is an interstitial layer, interposing the second bubble layer and a third bubble layer that forms a fifth layer. In one embodiment, this third bubble layer is the second outer layer. Alternatively, in another embodiment, a sixth layer, and second insulating layer, directly contacts the third bubble layer. In one embodiment, the second insulating layer forms the second outer layer. Alternatively, in another embodiment, a fourth bubble layer directly contacts the second insulating layer and forms the second outer layer.

A packing liner in an embodiment is formed in the shape of a bag or container. The sides of the bag are formed from a panel separate from the panel that is cut and folded to form the bag sides. In another embodiment, the bag is formed of a single panel. The bag may be formed of any shape suitable for lining a package for containing food items, such as a box or bag. In yet another embodiment, the packing liner is configured to form a bag itself. The packing liner may be configured to close and seal an interior of the bag or container formed thereof, and may include an attachment means such as an adhesive strip or hook and loop fastener.

An embodiment of methods useful for forming a packing liner includes providing a first outer layer, a first bubble layer, and an interstitial layer. Methods include attaching the outer layer in direct contact with a first side of the bubble layer, and attaching the interstitial layer to a second side of the bubble layer, sealing voids defined therein by structural material of the bubble layer. Methods include attaching a second bubble layer directly the interstitial layer on a first side of the second bubble layer, and attaching a second outer layer directly to a second side of the second bubble layer. Methods include forming the packing liner in the shape of a container or bag.

In an alternative embodiment of methods, the insulating layer formed of MYLAR, metallized polypropylene, metallized polyethylene, or nylon is a second layer. A first bubble layer is a first outer layer arranged to directly contact the second layer. A second bubble layer is arranged as a third layer, and second outer layer.

In another alternative embodiment, the insulating layer formed of MYLAR, metallized polypropylene, metallized polyethylene, or nylon is a second layer. A first bubble layer is arranged as a first outer layer directly contacting the second layer. A second bubble layer is arranged as a third layer, directly contacting the second layer, opposite the first bubble layer. A fourth layer is formed as an interstitial layer, interposing the second bubble layer and a third bubble layer that forms a fifth layer. In one embodiment, this third bubble layer is the second outer layer. Alternatively, in another embodiment, a sixth layer, and second insulating layer, is arranged to directly contact the third bubble layer. In one embodiment, the second insulating layer is arranged to form the second outer layer. Alternatively, in another embodiment, a fourth bubble layer is formed to directly contact the second insulating layer and forms the second outer layer.

Additional features and technical effects of the present disclosure will become readily apparent to those skilled in the art from the following detailed description wherein embodiments of the present disclosure are described simply by way of illustration of the best mode contemplated to carry out the present disclosure. In addition to the embodiments disclosed herein, other and different embodiments are within the spirit and scope of the disclosure, and its several details are capable of modifications in various respects.

### BRIEF DESCRIPTION OF DRAWINGS

The disclosure is shown by way of example in the figures of the accompanying drawings, in which like reference numerals refer to like elements.

FIG. 1 shows a perspective view of a multilayer packing liner formed in the shape of a bag having a bottom panel and side panel with side seams in accordance with an embodiment;

FIG. 2 shows a cross-sectional side view along line A of FIG. 1 in accordance with an embodiment;

FIG. 3 shows a top view in accordance with an embodiment;

FIG. 4 shows a bottom view in accordance with an embodiment;

FIG. 5 shows a side view in accordance with an embodiment;

FIG. 6 shows a perspective view of an interior of the packing liner formed in the shape of a bag in accordance with an embodiment;

FIG. 7 shows an end view in accordance with an embodiment;

FIG. 8 shows a method useful for manufacturing a multilayer bag or container in accordance with an embodiment.

### DETAILED DESCRIPTION OF EMBODIMENTS

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

Embodiments of multilayer packing liners and bags and containers formed therefrom are disclosed. Apparatus of embodiments advantageously insulate products include perishable food products that must be contained under temperatures maintained within specific ranges, for example, whether moderate to relatively extreme hot or cold.

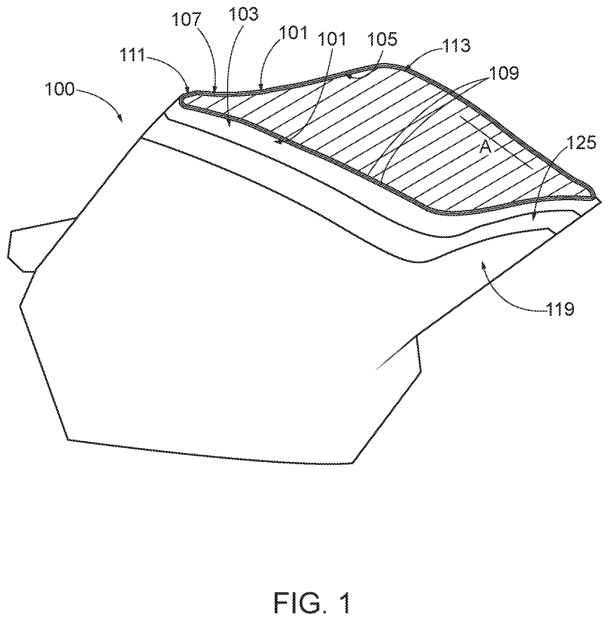

A multilayer packing liner apparatus useful for insulating and containment of food items is shown in FIG. 1. In particular, FIG. 1 shows a packing liner 100 including a first outer layer 101 comprising an insulating material. The outer layer 101 may be formed of foil. In an embodiment, the outer layer 101 is formed of MYLAR with a reflective outer first side 103. An inner second side 105 directly contacts a first bubble layer 107.

In another embodiment, the first outer layer 101 is formed of metallized polypropylene. In another embodiment, the outer layer may be formed of one or more materials selected from metallized polyethylene, and nylon. The first outer layer 101 may be formed of any now known or later developed insulating material in alternative embodiments.

The first bubble layer 107 may be formed of a polymeric material or plastic, or, synthetic or semi-synthetic organic polymer compounds. The first bubble layer 107 shown in FIG. 1 includes pliable transparent polymeric material forming protruding air-filled enclosures. In particular, the first bubble layer 107 includes polymeric material configured to define ‘bubbles’—structures 109 defining voids containing air sealed in and surrounded by the polymeric material, the second side 105 of the first outer layer 101, and an interstitial layer 111. The protruding air-filled enclosures are similar in form and construction to BUBBLE WRAP, manufactured by Sealed Air Corporation for providing cushioning of fragile items. In embodiments of the disclosure, the first bubble layer, and combination of an outer insulating layer, and in some embodiments, interstitial layers, provide a combined insulating function.

The interstitial layer 111 may be formed of MYLAR in one embodiment. In another embodiment, the interstitial layer 111 may be formed of a polymeric material. In another embodiment, the interstitial layer 111 may be formed of metallized polypropylene. In another embodiment, the outer layer may be formed of materials including MYLAR, metallized polypropylene, metallized polyethylene, and nylon. The interstitial layer 111 interposes the first bubble layer 107 and a second bubble layer 113. The second bubble layer 113 is formed of polymeric material and configured to define voids or ‘bubbles’ as in the first bubble layer 107. A second outer layer 117 directly contacts the second bubble layer 113 on a side thereof opposite the interstitial layer 111.

The first bubble layer 107 and the second bubble layer 113 are the only bubble layers of the packing liner 100 in one embodiment wherein the packing liner includes an interstitial layer interposing and directly contacting the bubble layers, a first outer layer directly contacting the first bubble layer opposite the interstitial layer, and a second outer layer directly contacting the second bubble layer opposite the interstitial layer, as shown in FIG. 1. In an alternative embodiment, a packing liner may include more than two bubble layers, each interposed by an interstitial layer. The first and second outer layers and the interstitial layer(s) of some embodiments form a portion of surfaces of the bubble layer that define and seal the voids therein.

In an embodiment, an advantageously enhanced effectiveness is provided by a combination of layers having the characteristics shown in Table 1. A second outer layer may be disposed on the side of the fourth layer opposite the third layer of the combination of layers shown in Table 1. In alternative embodiments, layers may be chosen from different suitable materials, and may configured with difference suitable densities or thicknesses.

TABLE 1

| Layer | Material | Density | Layer Thickness |
|---|---|---|---|
| First Outer Layer | PET Foil | 26 grams per | 22 microns |
| | | square meter | |
| Second Layer | LDPE bubble | 54 grams per | 20 microns |
| | | square meter | |
| Third Layer | PET foil | 35 grams per | 32 microns |
| | | square meter | |
| Fourth Layer | LDPE bubble | 54 grams per | 20 microns |
| | | square meter | |

The combination of layers and respective materials and characteristics shown in Table 1 are in accordance with any exemplary embodiment, and which have proven critical to highly desirable insulation properties and profile construction. Other embodiments of a packing liner include material layers in different numbers, orders, or with layers having materials of different characteristics such as type, density, or thickness, while still achieving the advantageous synergistic effect of efficient and effective insulation and a thin profile construction of the packing liner.

A packing liner in an embodiment is formed in the shape of a bag or container as shown in FIG. 1. The sides 119 of the bag may be formed from a panel separate from the panel that is cut and folded to form the bottom (not shown), or may be formed of the same panel, which may be cut, folded, and joined to form a bag or container shape. In another embodiment, the bag may be formed of any shape suitable for lining a package for containing food items, such as a box or bag. In yet another embodiment, the multilayer packing liner may be configured to form a bag itself. The multilayer packing liner may be configured to close and seal an interior of the bag or container formed thereof, and may include an attachment means such as an adhesive strip 125 or hook and loop fastener (not shown).

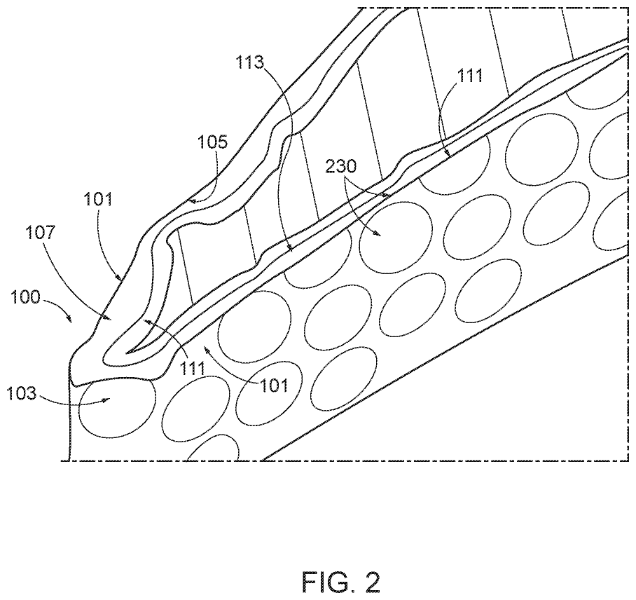

FIG. 2 shows a cross-sectional view along line A of FIG. 1. In particular, FIG. 2 shows the packing liner 100 including a first outer layer 101 comprising an insulating material. The outer layer 101 may be formed of foil. In an embodiment, the outer layer 101 is formed of MYLAR with a reflective outer first side 103. An inner second side 105 directly contacts a first bubble layer 107.

The packing liner 100 includes the first bubble layer 107 including a polymeric material configured to define ‘bubbles’—structures 109 defining voids containing air sealed in and surrounded by the polymeric material material, the second side 105 of the first outer layer 101, and the interstitial layer 111. The first bubble layer 107 may include a plurality of substantially equally spaced bubbles 230 extending a height of the first bubble layer 107, and sealed by the inner side 105 of the first outer layer and the interstitial layer 111.

The interstitial layer 111 interposes the first bubble layer 107 and a second bubble layer 113. The second bubble layer 113 is formed of polymeric material and configured to define voids or ‘bubbles’ as in the first bubble layer 107. The multiple layers of the packing liner, including a plurality of bubble layers, outer layers, and interstitial layer, arranged a shown in FIG. 2, accommodate enhanced insulating efficacy while enabling a thin packing material profile.

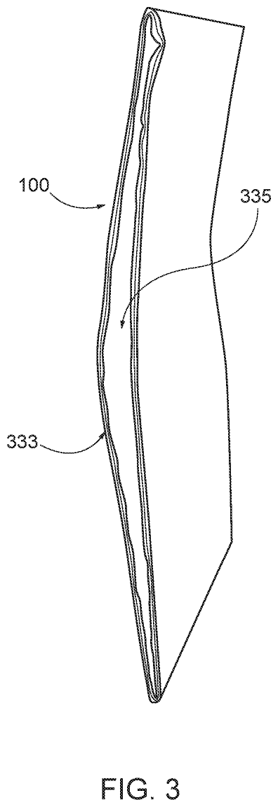

FIG. 3 shows a top view of a multilayer packing liner in accordance with an embodiment. In particular, FIG. 3 shows a top view of an insulating multilayer packing liner 100. The packing liner 100 includes a top portion 333 that is open to provide access to an interior 335 of the liner 100, which is formed in the shape of a bag.

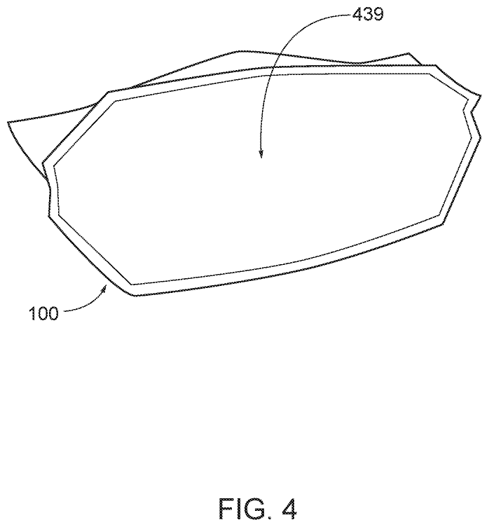

FIG. 4 shows a bottom view of a multilayer packing liner in accordance with an embodiment. In particular, FIG. 4 shows a bottom view of an insulating multilayer packing liner 100. The packing liner 100 includes a bottom 439. The bottom 439 may be a separate panel, or may be formed from a same panel that forms sides of a bag or container formed by the liner 100, as shown.

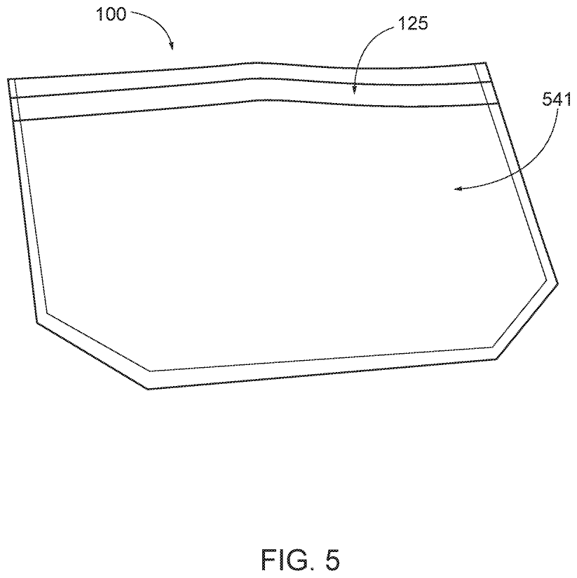

FIG. 5 shows a side view of a packing liner in accordance with another embodiment. In particular, FIG. 5 shows a side view of an insulating multilayer packing liner 100. Adhesive strips 125 or any suitable closure mechanism may be placed on a side 541 of the liner 100 for closing a liner shaped to form a container or bag. For example, the closure mechanism may be a hook and loop fastener, or snap-fit closure, or any now known or later developed device useful for closing and securing contents of a container or bag formed of the packing liner 100.

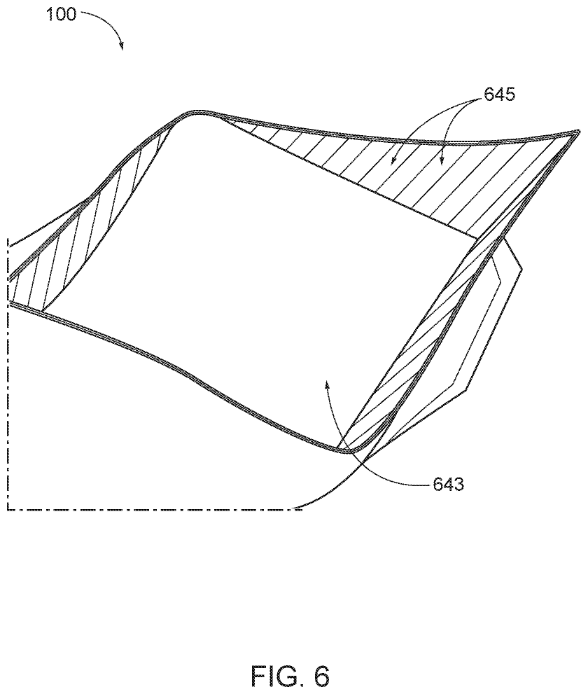

FIG. 6 shows a perspective view of an interior of a packing liner formed in the shape of a bag in accordance with an embodiment. In particular, FIG. 6 shows an inner interior surface 643 of an insulating multilayer packing liner 100 formed in the shape of a bag. The inner interior surface 643 is formed by an outer layer of the multilayer packing liner 100. In an embodiment, the multilayer packing liner 100 is formed to define evenly spaced ridges 645 that are configured and arranged to enhance an insulating function of the liner.

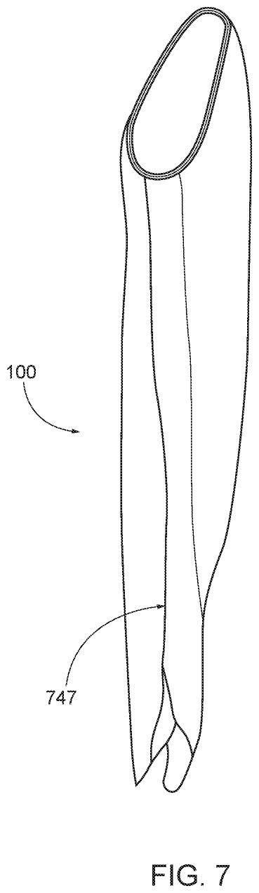

FIG. 7 shows an end view of a multilayer packing liner in accordance with an embodiment. In particular, FIG. 7 shows a liner 100 including sealed side edges 747. The sealed side edges 747 may be formed by heat-sealing, and/or by adhesive composition suitable for joining the liner 100 edges to form the sealed side edges 747.

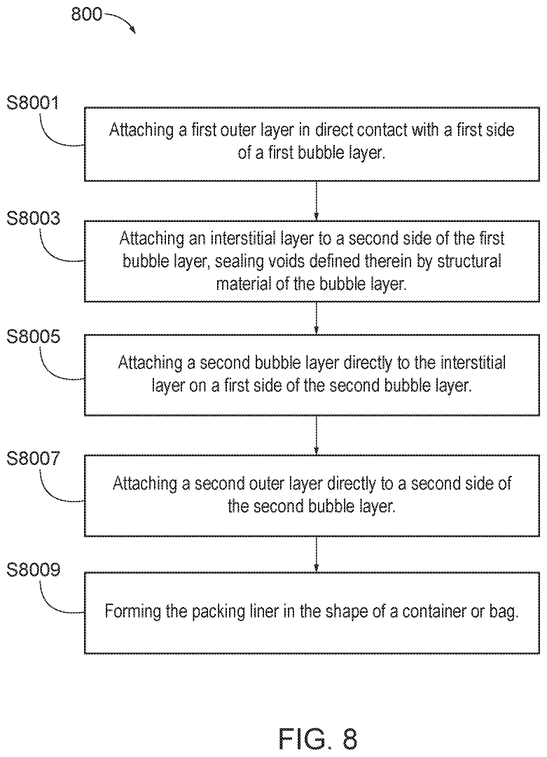

An embodiment of methods useful for forming a packing liner includes providing a first outer layer, a first bubble layer, and an interstitial layer as shown in FIG. 8. A method 800 includes attaching at S8001 the outer layer in direct contact with a first side of the bubble layer, and attaching at S8003 the interstitial layer to a second side of the bubble layer, sealing voids defined therein by structural material of the bubble layer. Methods include attaching at S8005 a second bubble layer directly the interstitial layer on a first side of the second bubble layer, and attaching at S8007 a second outer layer directly to a second side of the second bubble layer. Methods include forming at S8009 the packing liner in the shape of a container or bag. The materials used to form the various layers may be selected from the materials discloses herein, or any now known or later developed materials suitable for use in accordance with apparatus and methods of embodiments. By way of example, an embodiment having layers formed of materials with densities and thicknesses selected as shown in Table 1 has shown enhanced insulating efficiency and effectiveness for packing food and other temperature-sensitive items. Other combinations, numbers, and orders of layers and characteristics of specific materials may be selected and applied in accordance with the spirit scope of the embodiments disclosed herein.

Embodiments are shown by way of example, and not by way of limitation in the figures and drawings. While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A multilayer packing liner apparatus useful for insulating, comprising:
a first outer layer;
a first bubble layer;
an interstitial layer; and
a second bubble layer.

2. The apparatus of claim 1, comprising a second outer layer directly contacting the second bubble layer.

3. The apparatus of claim 1, the first outer layer further comprising an outer side and an inner side, the inner side directly contacting a first side of the first bubble layer.

4. The apparatus of claim 1, the first bubble layer further comprising a first side and a second side, the second side directly contacting the interstitial layer.

5. The apparatus of claim 1, the second bubble layer further comprising a first side and a second side, the first side directly contacting the interstitial layer.

6. The apparatus of claim 2, the second bubble layer further comprising a first side and a second side, the first side directly contacting the interstitial layer, the second side directly contacting the second outer layer.

7. The apparatus of claim 1, the first outer layer further comprising MYLAR.

8. The apparatus of claim 1, the first bubble layer comprising polymeric material.

9. The apparatus of claim 1, first outer layer further comprising MYLAR, the first bubble layer further comprising polymeric material, and the interstitial layer comprising MYLAR.

10. The apparatus of claim 1, the first outer layer further comprising metallized polypropylene.

11. The apparatus of claim 1, the first outer layer further comprising a material selected from the group comprising MYLAR, metallized polypropylene, metallized polyethylene, and nylon, the first bubble layer further comprising polymeric material, and the interstitial layer comprising a material selected from the group comprising MYLAR, metallized polypropylene, metallized polyethylene, and nylon.

12. The apparatus of claim 1, the first bubble layer further comprising a polymeric structure configured to define a plurality of voids, sealed by the polymeric structure and the first outer layer and the interstitial layer, the plurality of voids substantially equally distributed across the first bubble layer.

13. The apparatus of claim 12, the second bubble layer further comprising a polymeric structure configured to define a plurality of voids, sealed by the polymeric structure and a second outer layer and the interstitial layer, the plurality of voids substantially equally distributed across the second bubble layer.

14. The apparatus of claim 2, the liner shaped and configured to form a container.

15. The apparatus of claim 2, the liner shaped and configured to form a bag having two sealed side edges and a bottom panel.

16. The apparatus of claim 2, the liner shaped and configured to form a foldable container.

17. The apparatus of claim 1, the first outer layer, the first bubble layer, the interstitial layer, and the second bubble layer configured to form an insulating container useful for maintaining a temperature in a range of temperatures suitable for storing food items.

18. A method for forming a multilayer packing liner apparatus useful for containing food items, the method comprising:
attaching an outer layer in direct contact with a first side of a first bubble layer;
attaching an interstitial layer to a second side of the bubble layer, sealing voids defined therein by structural material of the bubble layer; and
attaching a second bubble layer directly the interstitial layer on a first side of the second bubble layer.

19. The method of claim 18, comprising attaching a second outer layer directly to a second side of the second bubble layer.

20. The method of claim 18, comprising forming the packing liner in the shape of a container or bag.
